(19) United States
(12) Patent Application Publication
(10) Pub. No.: US 2025/0008509 A1
(43) Pub. Date: Jan. 2, 2025

(54) PREVENTION OF OUT-OF-SYNCHRONIZATION STATE DUE TO USER EQUIPMENT TUNE-AWAY

(71) Applicant: QUALCOMM INCORPORATED, San Diego, CA (US)

(72) Inventors: Altaf Ahmed, San Diego, CA (US); Muhammad Arif Munif, San Diego, CA (US); Arvind Vardarajan Santhanam, San Diego, CA (US); Sumit Kumar Singh, San Marcos, CA (US); Akshay Sharma, San Diego, CA (US); Bhavana Pooja Perumal, San Diego, CA (US); Preeti Sivakumar, San Diego, CA (US); Sridhar Ramanujam, San Diego, CA (US); Saisruthi Kotamraju, Bengaluru (IN); Ling Xie, Beijing (CN); Abhimanyu Singh, Hyderabad (IN)

(21) Appl. No.: 18/705,961

(22) PCT Filed: Dec. 7, 2021
(86) PCT No.: PCT/CN2021/135980

§ 371 Date: Apr. 29, 2024

(51) Int. Cl. H04W 72/1268; H04B 7/06; H04L 1/1867; H04W 24/02; H04W 76/28

(52) U.S. Cl. CPC H04W 72/1268; H04B 7/0632; H04L 1/1896; H04W 24/02; H04W 76/28

(57) ABSTRACT

Methods, systems, and devices for wireless communication are described. A user equipment (UE) may generate a scheduling request for transmission to a base station. The UE may pause a transmission of the scheduling request according to an overlap in time between a response window associated with the scheduling request and a scheduled tuneaway period of the UE. The UE may tune away from the base station during the tuneaway period. The UE may transmit the scheduling request after a completion of the tuneaway period according to the pausing.

### CROSS REFERENCE

The present Application is a 371 national stage filing of International PCT Application No. PCT/CN2021/135980 by Ahmed et al. entitled “PREVENTION OF OUT-OF-SYNCHRONIZATION STATE DUE TO USER EQUIPMENT TUNE-AWAY,” filed Dec. 7, 2021, which is assigned to the assignee hereof, and which is expressly incorporated by reference in its entirety herein.

### FIELD OF TECHNOLOGY

The following relates to wireless communication, including prevention of out-of-synchronization state due to user equipment tune-away.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

The described techniques relate to improved methods, systems, devices, and apparatuses that support prevention of out-of-synchronization state due to user equipment tune-away. Generally, the described techniques provide for a user equipment (UE) delaying scheduling request (SR) transmissions due to an upcoming uplink transmission. For example, the UE may identify or otherwise determine a response window associated with the SR. Broadly, the response window may correspond to the time the UE expects to receive the uplink grant in response to the SR. If the response window overlaps with an upcoming tuneaway, the UE may pause or otherwise delay transmitting the SR before the tuneaway and, instead, transmit the SR after the tuneaway. Accordingly, the UE may avoid an out-of-synchronization condition with the base station due to the tuneaway procedure.

A method for wireless communications at a UE is described. The method may include generating a SR for transmission to a base station, pausing a transmission of the SR according to an overlap in time between a response window associated with the SR and a scheduled tuneaway period of the UE, tuning away from the base station during the tuneaway period, and transmitting the SR after a completion of the tuneaway period according to the pausing.

An apparatus for wireless communications at a UE is described. The apparatus may include a processor, memory coupled with the processor, and instructions stored in the memory. The instructions may be executable by the processor to cause the apparatus to generate a SR for transmission to a base station, pause a transmission of the SR according to an overlap in time between a response window associated with the SR and a scheduled tuneaway period of the UE, tune away from the base station during the tuneaway period, and transmit the SR after a completion of the tuneaway period according to the pausing.

Another apparatus for wireless communications at a UE is described. The apparatus may include means for generating a SR for transmission to a base station, means for pausing a transmission of the SR according to an overlap in time between a response window associated with the SR and a scheduled tuneaway period of the UE, means for tuning away from the base station during the tuneaway period, and means for transmitting the SR after a completion of the tuneaway period according to the pausing.

A non-transitory computer-readable medium storing code for wireless communications at a UE is described. The code may include instructions executable by a processor to generate a SR for transmission to a base station, pause a transmission of the SR according to an overlap in time between a response window associated with the SR and a scheduled tuneaway period of the UE, tune away from the base station during the tuneaway period, and transmit the SR after a completion of the tuneaway period according to the pausing.

Some examples of the method, apparatuses, and non-transitory computer-readable medium described herein may further include operations, features, means, or instructions for determining a receive time for one or more grants of uplink resources for an uplink transmission associated with the SR, where the response window may be based on the receive time, where pausing the transmission of the SR may be based on the receive time occurring within the tuneaway period.

In some examples of the method, apparatuses, and non-transitory computer-readable medium described herein, the determining may be based on a machine-learning function or an estimation function performed at the UE.

Some examples of the method, apparatuses, and non-transitory computer-readable medium described herein may further include operations, features, means, or instructions for determining a historical receive time for one or more previous grants of uplink resources for respective uplink transmission associated with SRs and determining, based on the historical receive time, a receive time for one or more grants of uplink resources for an uplink transmission associated with the SR, where the response window may be based on the receive time, where pausing the transmission of the SR may be based on the receive time occurring within the tuneaway period.

Some examples of the method, apparatuses, and non-transitory computer-readable medium described herein may further include operations, features, means, or instructions for determining a receive time for a one or more grants of uplink resources for an uplink transmission associated with the SR, where the response window may be based on the receive time and transmitting an indication of the response window to the base station, where subsequent SRs may be paused based on the indication.

In some examples of the method, apparatuses, and non-transitory computer-readable medium described herein, the indication may be transmitted via at least one of a UE assistance information request message, a medium access control-control element (MAC-CE), or both.

Some examples of the method, apparatuses, and non-transitory computer-readable medium described herein may further include operations, features, means, or instructions for determining a connected-mode discontinuous reception (CDRX) cycle associated with the UE, the CDRX cycle including the UE transitioning between a connected mode with the base station and an inactive or idle mode with the base station, where the response window may be based on the CDRX cycle.

Some examples of the method, apparatuses, and non-transitory computer-readable medium described herein may further include operations, features, means, or instructions for determining a roundtrip time (RTT) for transmissions between the UE and the base station, where the response window may be based on the RTT.

Some examples of the method, apparatuses, and non-transitory computer-readable medium described herein may further include operations, features, means, or instructions for determining that the SR may be associated with a channel quality indicator (CQI) associated with a channel between the UE and the base station, where the response window may be based on the channel quality information (CQI).

Some examples of the method, apparatuses, and non-transitory computer-readable medium described herein may further include operations, features, means, or instructions for determining at least one of a transmit time interval bundling configuration, a hybrid automatic repeat/request (HARQ) feedback configuration, or both, configured for the UE, where the response window may be based on the determining.

A method for wireless communications at a base station is described. The method may include receiving, from a UE, an indication of a response window associated with the UE, the response window based on an overlap in time between the response window associated with a first SR of the UE and a scheduled tuneaway period of the UE where the UE tunes away from the base station, receiving a second SR from the UE requesting a grant of uplink resources for an uplink transmission associated with the second SR, and scheduling transmission of one or more grants of the uplink resources for the uplink transmission based on the response window of the UE.

An apparatus for wireless communications at a base station is described. The apparatus may include a processor, memory coupled with the processor, and instructions stored in the memory. The instructions may be executable by the processor to cause the apparatus to receive, from a UE, an indication of a response window associated with the UE, the response window based on an overlap in time between the response window associated with a first SR of the UE and a scheduled tuneaway period of the UE where the UE tunes away from the base station, receive a second SR from the UE requesting a grant of uplink resources for an uplink transmission associated with the second SR, and scheduling transmission of one or more grants of the uplink resources for the uplink transmission base at least in part on the response window of the UE.

Another apparatus for wireless communications at a base station is described. The apparatus may include means for receiving, from a UE, an indication of a response window associated with the UE, the response window based on an overlap in time between the response window associated with a first SR of the UE and a scheduled tuneaway period of the UE where the UE tunes away from the base station, means for receiving a second SR from the UE requesting a grant of uplink resources for an uplink transmission associated with the second SR, and means for scheduling transmission of one or more grants of the uplink resources for the uplink transmission based on the response window of the UE.

A non-transitory computer-readable medium storing code for wireless communications at a base station is described. The code may include instructions executable by a processor to receive, from a UE, an indication of a response window associated with the UE, the response window based on an overlap in time between the response window associated with a first SR of the UE and a scheduled tuneaway period of the UE where the UE tunes away from the base station, receive a second SR from the UE requesting a grant of uplink resources for an uplink transmission associated with the second SR, and scheduling transmission of one or more grants of the uplink resources for the uplink transmission base at least in part on the response window of the UE.

Some examples of the method, apparatuses, and non-transitory computer-readable medium described herein may further include operations, features, means, or instructions for determining that the UE may be scheduled to tune away from the base station during the response window and scheduling a receive time for the one or more grants until after the tuneaway of the UE based on the response window and the tuneaway.

Some examples of the method, apparatuses, and non-transitory computer-readable medium described herein may further include operations, features, means, or instructions for determining a CDRX cycle associated with the UE, the CDRX cycle including the UE transitioning between a connected mode with the base station and an inactive or idle mode with the base station, where the response window may be based on the CDRX cycle.

In some examples of the method, apparatuses, and non-transitory computer-readable medium described herein, the response window may be based on a receive time for a received grant, a historical receive time for one or more previous grants, or both.

In some examples of the method, apparatuses, and non-transitory computer-readable medium described herein, the indication may be received via at least one of a UE assistance information request message, a MAC-CE, or both.

### BRIEF DESCRIPTION OF THE DRAWINGS

FIG. 1 illustrates an example of a wireless communications system that supports prevention of out-of-synchronization state due to user equipment (UE) tune-away in accordance with aspects of the present disclosure.

FIG. 2 illustrates an example of a wireless communications system that supports prevention of out-of-synchronization state due to UE tune-away in accordance with aspects of the present disclosure.

FIG. 3 illustrates an example of a timeline that supports prevention of out-of-synchronization state due to UE tune-away in accordance with aspects of the present disclosure.

FIG. 4 illustrates an example of a process that supports prevention of out-of-synchronization state due to UE tune-away in accordance with aspects of the present disclosure.

FIGS. 5 and 6 show block diagrams of devices that support prevention of out-of-synchronization state due to UE tune-away in accordance with aspects of the present disclosure.

FIG. 7 shows a block diagram of a communications manager that supports prevention of out-of-synchronization state due to UE tune-away in accordance with aspects of the present disclosure.

FIG. 8 shows a diagram of a system including a device that supports prevention of out-of-synchronization state due to UE tune-away in accordance with aspects of the present disclosure.

FIGS. 9 and 10 show block diagrams of devices that support prevention of out-of-synchronization state due to UE tune-away in accordance with aspects of the present disclosure.

FIG. 11 shows a block diagram of a communications manager that supports prevention of out-of-synchronization state due to UE tune-away in accordance with aspects of the present disclosure.

FIG. 12 shows a diagram of a system including a device that supports prevention of out-of-synchronization state due to UE tune-away in accordance with aspects of the present disclosure.

FIGS. 13 through 17 show flowcharts illustrating methods that support prevention of out-of-synchronization state due to UE tune-away in accordance with aspects of the present disclosure.

### DETAILED DESCRIPTION

User equipment (UE) may perform tune-away from its serving base station for various reasons, e.g., monitoring channels of candidate cells, monitoring for other radio access technologies (RATs), etc. Some tune-away cases may coincide with uplink transmissions from the UE. For example, the UE may have a scheduling request (SR) for transmission requesting uplink resources for the uplink transmission. However, the tuneaway may occur after the UE sends the SR and the corresponding uplink grant may be received during the tuneaway. The UE may miss the uplink grant and therefore miss performing the uplink transmission on the allocated resources. The base station, expecting the uplink transmission due to the uplink grant, may miss the uplink transmission and perform retransmissions of the uplink grant. This may result in wasted resources and a loss of communication between the UE and base station. For example, the base station missing the uplink transmissions may determine that the UE has experienced a link failure, resulting in further disruption and loss of communication between the UE and base station.

Generally, the described techniques provide for a UE delaying SR transmissions due to an upcoming uplink transmission. For example, the UE may identify or otherwise determine a response window associated with the SR. Broadly, the response window may correspond to the time the UE expects to receive the uplink grant in response to the SR. If the response window overlaps with an upcoming tuneaway, the UE may pause or otherwise delay transmitting the SR before the tuneaway and, instead, transmit the SR after the tuneaway. Accordingly, the UE may avoid an out-of-synchronization condition with the base station due to the tuneaway procedure.

Aspects of the disclosure are initially described in the context of wireless communications systems. Aspects of the disclosure are further illustrated by and described with reference to apparatus diagrams, system diagrams, and flowcharts that relate to prevention of out-of-synchronization state due to UE tune-away.

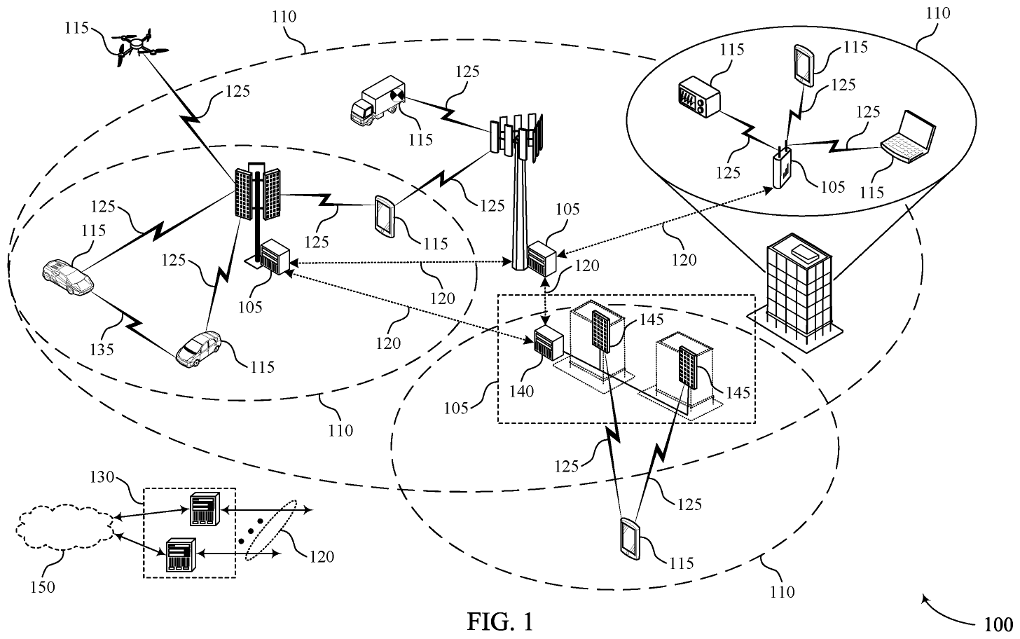

FIG. 1 illustrates an example of a wireless communications system 100 that supports prevention of out-of-synchronization state due to UE tune-away in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

In some examples, one or more components of the wireless communications system 100 may operate as or be referred to as a network node. As used herein, a network node may refer to any UE 115, base station 105, entity of a core network 130, apparatus, device, or computing system configured to perform any techniques described herein. For example, a network node may be a UE 115. As another example, a network node may be a base station 105. As another example, a first network node may be configured to communicate with a second network node or a third network node. In one aspect of this example, the first network node may be a UE 115, the second network node may be a base station 105, and the third network node may be a UE 115. In another aspect of this example, the first network node may be a UE 115, the second network node may be a base station 105, and the third network node may be a base station 105. In yet other aspects of this example, the first, second, and third network nodes may be different. Similarly, reference to a UE 115, a base station 105, an apparatus, a device, or a computing system may include disclosure of the UE 115, base station 105, apparatus, device, or computing system being a network node. For example, disclosure that a UE 115 is configured to receive information from a base station 105 also discloses that a first network node is configured to receive information from a second network node. In this example, consistent with this disclosure, the first network node may refer to a first UE 115, a first base station 105, a first apparatus, a first device, or a first computing system configured to receive the information; and the second network node may refer to a second UE 115, a second base station 105, a second apparatus, a second device, or a second computing system

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of TS=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

A UE 115 may generate a SR for transmission to a base station 105. The UE 115 may pause a transmission of the SR according to an overlap in time between a response window associated with the SR and a scheduled tuneaway period of the UE 115. The UE 115 may tune away from the base station 105 during the tuneaway period. The UE 115 may transmit the SR after a completion of the tuneaway period according to the pausing.

A base station 105 may receive, from a UE 115, an indication of a response window associated with the UE 115, the response window based at least in part on an overlap in time between the response window associated with a first SR of the UE 115 and a scheduled tuneaway period of the UE 115 where the UE 115 tunes away from the base station 105. The first SR in this example may generally correspond to one or more previously reported SR(s) with accompanying grants being receive. The base station 105 may receive a second SR from the UE 115 requesting a grant of uplink resources for an uplink transmission associated with the second SR. The base station 105 may schedule transmission of one or more grants of the uplink resources for the uplink transmission based at least in part on the response window of the UE 115. The second SR in this example may generally correspond to any SR subsequent to the network being informed of the response window of the UE 115.

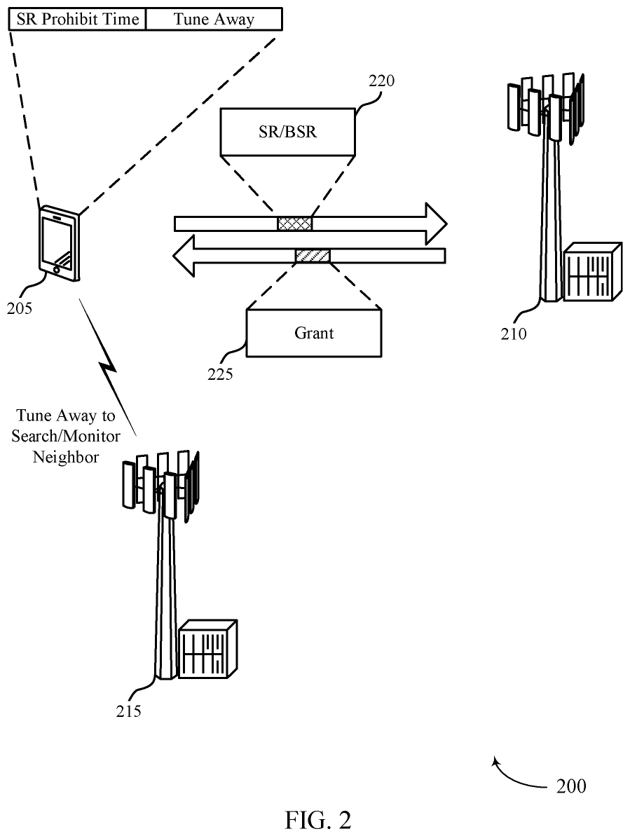

FIG. 2 illustrates an example of a wireless communications system 200 that supports prevention of out-of-synchronization state due to UE tune-away in accordance with aspects of the present disclosure. Wireless communications system 200 may implement aspects of wireless communications system 100. Wireless communications system 200 may include UE 205, base station 210, and base station 215. In some examples, base station 210 may be an example of a serving base station/cell of UE 205 and base station 215 may be an example of a neighboring base station (e.g., a potential handover candidate/target). In some examples, base station 210 and base station 215 may be examples of NR base stations (e.g., gNBs) and/or LTE base stations (e.g., eNBs). Generally, references to base station 210 and/or base station 215 may refer to the radio access network (RAN) and/or to the network (e.g., one or more components, functions, etc., within the core network).

Wireless communications systems are generally heterogenous networks. For example, deployments may include overlapping networks utilizing different radio access technologies (RATs) (e.g., legacy networks, LTE networks, NR networks, WiFi networks, etc.). Moreover, some networks may be equipped to support single subscriber identity module (SSIM) and multiple subscriber identity module (MSIM) devices where the device can communicate on separate networks based on the different SIM cards. Another example may include the different networks being out-of-synchronization in the time and/or frequency domain (e.g., LTE-to-NR and even NR-to-NR networks in some examples).

Accordingly, UE 205 may perform tune-away procedures where UE 205 tunes away from its serving base station/cell (e.g., base station 210 in this example) and tunes to neighboring base station(s)/cell(s) to search for candidates for a potential handover, to monitor the neighbor(s) for channel performance measurements, to monitor for paging associated with a different subscriber (e.g., SIM). This may result in the situation where any UE (e.g., UE 205) initiated tune-away occurs without the network being informed of the tune-away (e.g., within the X2NR RAT, where X=4G or 5G cell). This may occur in networks configured with and without an over-the-air (OTA) gap period (e.g., gap(s) in the time domain) and/or with or without a NR measurement object. Some situations where this may occur may include, but are not limited to, autonomous UE measurements of a finger-printed NR cell (e.g., a known NR neighbor), the presence of a system information block 24 (SIB24) indicated entity in the LTE network, active MSIM switching between multiple subscribers to measure (which may cause gaps/measurements as interruptions), and the like.

Accordingly, UE 205 may be configured with or otherwise support SSIM and MSIM operations within wireless communications system 200. UE 205 may tune away in the X2NR RAT (where X-LTE or NR) for autonomous measurement gap, multi-SIM tune away, etc. The autonomous measurement gap may be created (e.g., configured) to support the serving network configuring the measurement gap, which may not cover a synchronization signal block (SSB) window in the target network (e.g., base station 215) due to the asynchronous target network with respect to the serving network (e.g., base station 210). The autonomous measurement gap may be configured because the serving network does configure a measurement gap.

In some situations, these autonomous tune away procedures performed by UE 205 may result in communication interruptions with respect to its serving network (e.g., with base station 210). When UE 205 tunes away from base station 210 without informing the serving network, the network loses track of UE 205 and may consider this an error condition, which may result in the network (e.g., via base station 210) requesting (re)transmissions of missing data/period. As one non-limiting example, when the network receives a grant request (e.g., scheduling request (SR)/buffer status report (BSR)) from UE 205 before an autonomous tune-away (e.g., UE 205 going out of synchronization with the network), the network may expect data (e.g., an uplink transmission) in response in subsequent transmission from UE 205, which may be missed due to UE 205 tuning away without informing the network.

More particularly, one issue that may arise occurs when UE 205 has uplink data to send around this point (e.g., just before the tune-away period or during the initial tune-away period). For example, when UE 205 sends out a SR requesting permission to send data, the base station (e.g., an eNB) may take up to a 4 ms (FDD) or 6 ms (TDD) delay to respond after allocating uplink resources (e.g., via downlink control information 0 (DCI 0)). This delay period may be identified via the configuration (e.g., FDD or TDD), based on machine learning techniques, and the like. When UE 205 tunes away without informing the serving network (e.g., after transmitting a SR/BSR, which may generally be referred to as a SR), UE 205 may miss the downlink grants sent by the network (e.g., via base station 210). This may result in the network losing track of UE 205 and, in response, considering this as an error condition, which may lead to the network requesting (re)transmissions of the missing data/period via base station 210. Specifically, when a network receives a grant or scheduling request just before tune-away (e.g., UE 205 going out of synchronization), the network may provide the grant 225 (e.g., for uplink resources) for the UE request (e.g., SR/BSR) and expects data in response to the allocation in subsequent transmission from UE 205. This may be missed due to the UE tuning away without informing the network.

The asynchronous or out-of-context situation in turn may create a domino effect of HARQ retransmission processes until the HARQ process exhausts all possible uplink retransmission tries (which may include up to 8 retransmission). This may result in downlink and uplink block error rate (BLER) observed by UE 205 (e.g., a BLER that exceeds an acceptable threshold). The gap period (e.g., the tune away period) may be observed as a discontinuous transmission period (DTX) by the network. This may negatively impact base station and UE resource utilization. Due to this condition, UE 205 may fail to achieve higher throughput and instead end up allocating resources to process downlink HARQ retransmission requests.

Accordingly, aspects of the techniques described herein address this issue, among others, and may result in improved performance of UE 205 in terms of minimizing BLER and achieving higher throughput. Broadly, this may include UE 205 delaying (e.g., autonomously without reporting to or otherwise coordinating with the network) scheduling or sending the SR/BSR 220 when a tune-away period is imminent. This may include the software module (e.g., internet protocol (IP) protocol layer or stack, which may also be referred to as a gap manager)) calculating an upcoming tune-away period (e.g., the start time and end time) and informing other modules (e.g., a grant manager) ahead of time.

For example, UE 205 may identify or otherwise determine that it has information to provide (e.g., uplink information/data to be provided to the network via base station 210). This may include one or more buffers of UE 205 storing uplink information, an upcoming transmission (e.g., channel performance feedback report) occurring, and the like. Accordingly, UE 205 may generate, package, identify, or otherwise determine a SR (e.g., SR/BSR 220) for transmission to the network (e.g., via base station 210). The SR/BSR 220 may generally carry or otherwise convey a request for resources (e.g., time resources, frequency resources, spatial resources, code resources, etc.) to use for performing the uplink transmission.

However, UE 205 may stop, pause, or otherwise refrain from transmitting the SR/BSR 220 based on an upcoming tune away to be performed by UE 205. For example, UE 205 may identify or otherwise determine a response window for the SR/BSR 220 and the tune-away procedure. Broadly, the response window may correspond to when (e.g., in the time domain) UE 205 would expect to receive a response to SR/BSR 220 (e.g., when UE 205 expects to receive grant 225 in response to transmitting SR/BSR 220). The response window may be based on the receive time of grant 225 (which may include one or more grants of uplink resources transmitted from base station 210 in response to SR/BSR 220). The response window may correspond to a SR prohibit time that precedes (e.g., in the time domain) the scheduled tune-away procedure of UE 205. That is, the response window preceding a tune-away procedure may define the time in which, if UE 205 were to transmit SR/BSR 220 during the response window, UE 205 would expect the corresponding grant 225 to arrive during the tune-away procedure (e.g., while UE 205 would be out of synchronization with base station 210). Accordingly, the response window may identify the time period in which UE 205 may avoid transmitting a SR/BSR before an upcoming tune-away procedure to avoid missing the corresponding grant(s).

Accordingly, UE 205 may tune away from base station 210 during the tune-away period (e.g., the tune-away procedure) and transmit SR/BSR 220 after completion of the tune-away period. That is, UE 205 may pause SR/BSR 220 transmission during the response window (e.g., during the SR prohibit time), perform the tune-away procedure (e.g., to tune to and monitor base station 215), and then transmit SR/BSR 220 after the tune-away period. This may prevent grant 225 arriving at UE 205 while UE 205 has tuned away from base station 210, thus missing the grant and stumbling into the direct and/or domino issues discussed above.

UE 205 may measure, calculate, monitor, identify, or otherwise determine the receive time for grant 225 (e.g., one or more grants of uplink resources). The response window may be identified or otherwise measured using various techniques. In some aspects, this calculation may consider the network delay caused by sending the grant response to UE 205. In some aspects, this calculation may consider the probability of the grant reaching UE 205 during the tune-away period. In some aspects, this calculation may consider the network (e.g., via base station 210) sending multiple grants in response to the SB/BSR 220. In some aspects, this calculation may consider the roundtrip time (RTT) for transmissions between UE 205 and base station 210. In some aspects, this calculation may consider the connected-mode discontinuous reception (CDRX) cycle of UE 205 (e.g., a power saving mechanism).

One example may include UE 205 using a machine learning function and/or an estimation function to measure, identify, or otherwise determine the response window. For example and for every SR/BSR 220 in the scheduling pipeline, before transmitting a SR/BSR 220 UE 205 may perform certain functions. For example, UE 205 may machine learn and/or otherwise estimate (e.g., using an estimation function) the non-zero SR prohibit time by calculating the delay from SR/BSR 220 (e.g., transmit time) to the gap start and end time (e.g., the tune-away procedure start and end times). Within the SR prohibit time for a physical uplink shared channel (PUSCH) transmission (e.g., an uplink transmission), this may be zero. UE 205 may hold (e.g., pause) the SR/BSR 220 during the SR prohibit time (e.g., do not transmit SR/BSR 220 during the response window). Coming back from the tune-away, UE 205 may send SR/BSR 220 on any subsequent PUSCH. The correct BSR may be sent (e.g., the full SR/BSR 220). Accordingly, in this example UE 205 may employ a machine-learning function and/or estimation function to determine the receive time for grant 225 identifying uplink resources for an uplink transmission associated with SR/BSR 220.

Another example may be based on historical (e.g., observed or otherwise fingerprinted instances) receive time. The historical receive time may be based on previous SR/BSR transmission(s) and the corresponding grant(s) of uplink resources. UE 205 may measure or otherwise determine the historical receive time by measuring the delay between a SR/BSR transmission and receiving the corresponding grant. UE 205 may maintain historical receive time information based on the most recent X SR/BSR transmissions and the receipt of the corresponding grants, where X is a positive integer. For example and with every SR/BSR in the scheduler pipeline, UE 205 may perform certain functions. UR 205 may estimate the non-zero BSR “SR prohibit time” by calculating the delay from SR to the gap start and end time (e.g., the start and end times of the tune-away period). This calculation may be based on already occurred delay periods in previous windows (e.g., the previous X SR/BSR transmissions and receipt of the corresponding grants). This calculation may be based on already fingerprinted database with autonomous gap configuration including periodicity, timer, scaling and gain factors. Within the SR prohibit time for a PUSCH transmission, the transmission may be zero. UE 205 may hold the SR/BSR during the SR prohibit time (e.g., does not transmit). Coming back from the tune-away, UE 205 may send the SR/BSR transmission on any subsequent PUSCH where the correct BSR may be sent.

Another example may be based on the CDRX cycle of UE 205. That is, UE 205 may adopt a CDRX cycle as part of a power saving mechanism. The CDRX cycle may include periods where UE 205 operates in a connected mode with base station 210 or in an inactive or idle mode with base station 210. The connected mode may correspond to periods where UE 205 and base station 210 have an active connection established to support wireless communications. The idle mode may correspond to periods where UE 205 powers down or otherwise minimizes power consumption of various modules/functions to conserve power. The inactive mode may correspond to periods where UE 205 maintains at least some context information with respect to base station 210, and vice versa, which may reduce delays in transitioning to the connected mode. In some aspects of this example, the response window of UE 205 may be based on the CDRX cycle of UE 205. For example, an inactive or idle mode period beginning before and extending into the SR prohibit time may extend the response window.

Another example may be based on the RTT for the channel between UE 205 and base station 210. For example, when UE 205 is an edge UE (e.g., near the edge of the coverage area of base station), the RTT may be long enough that the response window of UE 205 is extended for a period that is based on the RTT.

Another example may be based on the SR/BSR transmission being associated with a channel quality indicator (CQI) associated with the channel between UE 205 and base station 210. For example, the response window may consider or otherwise be based on any CQI requests of UE 205, whether it is period in nature (e.g., UE 205 initiated) or aperiodic (e.g., network requested). UE 205 and/or base station 210 may avoid transmitting and/or scheduling, respectively, the CQI report during the tune-away period of UE 205.

Another example may be based on transmit time interval (TTI) bundling and/or HARQ retransmission of UE 205. For example, UE 205 may be configured with TTI bundling (e.g., a TTI bundling configuration) where consecutive symbols in the time domain are allocated for transmission in a given direction (e.g., uplink or downlink). The HARQ feedback configuration may correspond to expected HARQ transmissions in response to the transmissions provided according to the TTI bundling configuration. The TTI bundling and/or HARQ feedback configuration may interfere with, overlap, etc., with the response window and/or upcoming tune-away period of UE 205, and therefore the response window may be based on (e.g., consider) the TTI bundling and HARQ feedback configurations of UE 205.

Another example may be based on the channel noise factor where retransmissions may be received even before the SR prohibit time. That is, the channel performance may provide an indication of the expected transmission success over the channel, which may also consider one or more retransmissions based on the channel performance. The SR prohibit time may be considered when transmitting an SR/BSR in this situation to avoid an expected retransmission being received during the tune-away period. For example, base station 210 may delay scheduling one or more retransmissions based on the response window.

In some examples, UE 205 may report its response window to base station 210 (e.g., to the network via base station 210). For example, UE 205 may identify or otherwise determine the response window (e.g., the SR prohibit time) as discussed herein. UE 205 may transmit an indication of the response window to base station 210. The indication may be transmitted in a UE assistance information request message, in a medium access control (MAC) control element (CE), and the like. In some examples, the indication is communicated to the network via the UE assisted information procedure.

Base station 210 (e.g., the network) may receive or otherwise obtain the indication of the response window from UE 205 and make scheduling decisions accordingly (e.g., the network may comply with the new timeline schedule, such as scheduling subsequent grants). That is, UE 205 indicating its response window may provide a timeline in which, when subsequent SR/BSR transmissions are received from UE 205, the corresponding grant(s) of uplink resources may be transmitted based on the response window of UE 205 (e.g., may be scheduled so as to arrive at UE 205 prior to the tune-away period). Accordingly, base station 210 may receive or otherwise obtain a subsequent (e.g., second) SR/BSR from UE 205 may schedule transmission of grant(s) of uplink resources in response based on the response window. For example, base station 205 may make such scheduling decisions as scheduling the receive time for the grant(s) until after the tune-away period of UE 205.

Accordingly, these techniques may provide for UE 205 sending the SR/BSR 220 after the tune-away period when UE 205 is again connected to base station 210 in order to receive and process the corresponding DCI grants (e.g., grant 225). This may avoid throughput loss, BLER, etc., in uplink and/or downlink due to unaccounted for HARQ retransmissions. Furthermore, this may provide for more efficient resource utilization by base station 210 and UE 205.

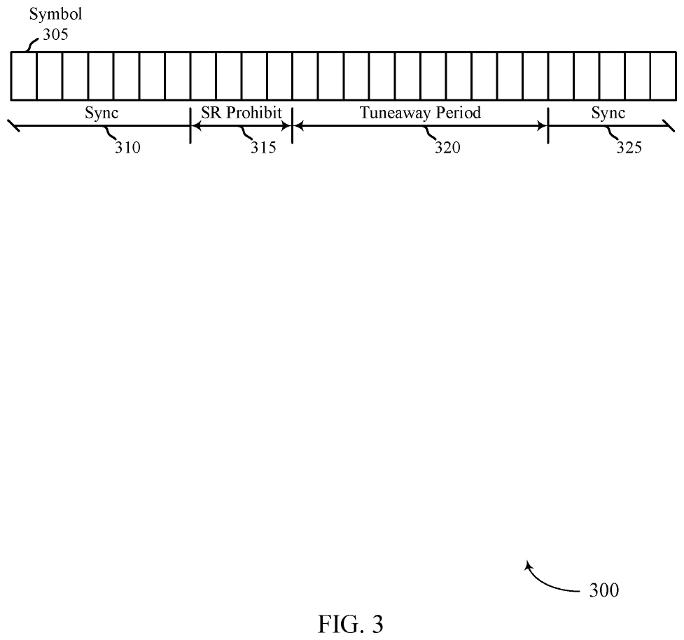

FIG. 3 illustrates an example of a timeline 300 that supports prevention of out-of-synchronization state due to UE tune-away in accordance with aspects of the present disclosure. Timeline 300 may implement aspects of wireless communications systems 100 and/or 200. Aspects of timeline 300 may be implemented at or implemented by a UE and/or base station, which may be examples of the corresponding devices described herein.

As discussed above, aspects of the techniques described herein provide for a UE to autonomously (e.g., without network coordination via a serving base station/cell) pause a SR/BSR transmission based on a response window of the UE. For example, the UE may generate the SR (e.g., the SR/BSR transmission) for transmission to the base station, but may pause the SR transmission based on the overlap (e.g., in the time domain) between the response window and a scheduled tune-away period. That is, the response window may define when the UE expects to receive a grant relative to the corresponding SR transmission. If the response window overlaps in the time domain with the upcoming tune-away period of the UE, the UE may pause the SR transmission and instead perform the tune-away procedure during the tune-away period. The UE may transmit the SR after the tune-away period.

For example, during time period 310 the UE may be in synchronization with its serving base station/cell (e.g., may be tuned to its serving base station/cell). This may span a number of symbols 305, with seven symbols 305 being shown by way of example only. However, the UE may have a SR transmission to perform and therefore determine a response window for the SR transmission. The response window may correspond to the SR prohibit period 315, which spans four symbols 305 by way of one non-limiting example. The SR prohibit period 315 may be based on or otherwise correspond to the response window of the UE and may provide a time period in which, if the UE were to transmit the SR transmission during the SR prohibit period 315, the corresponding grant would be expected to be received during the tune-away period 320, which spans 10 symbols 305 by way of one non-limiting example. Accordingly, SR prohibit period 315 may correspond to the symbols 305 in which the UE pauses transmitting the SR. The UE may also pause the SR during the tune-away period 320. After the tune-away period 320, the UE again tunes back to its serving base station/cell (e.g., returns to being in synchronization) during time period 325. The UE may transmit the SR to the base station during time period 325 (e.g., after the tune-away period 320 is completed).

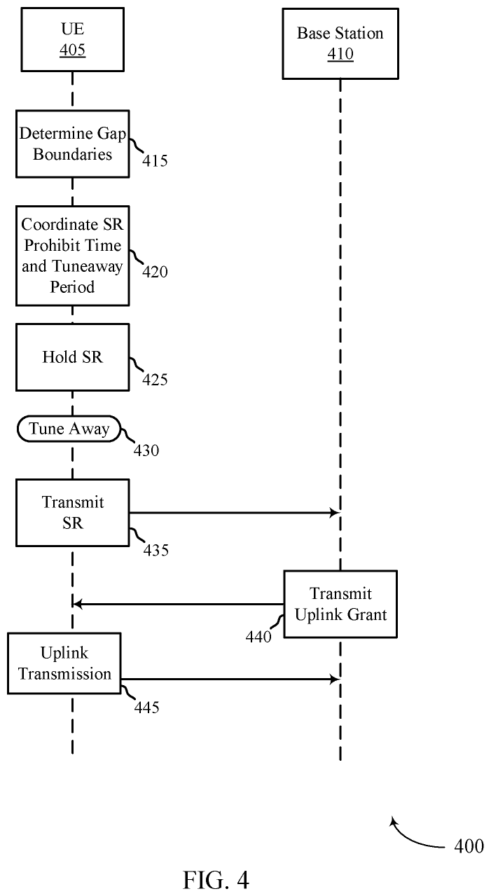

FIG. 4 illustrates an example of a process 400 that supports prevention of out-of-synchronization state due to UE tune-away in accordance with aspects of the present disclosure. Process 400 may implement aspects of wireless communications systems 100 and/or 200, and/or timeline 300. Aspects of process 400 may be implemented at or implemented by UE 405 and/or base station 410, which may be examples of the corresponding devices described herein.

At 415, UE 405 may identify or otherwise determine that a tune-away procedure is to be performed by the UE where UE 405 tunes away from base station 410 for a tune-away period. Accordingly, UE 405 may identify or otherwise determine the gap boundaries for the tune-away procedure. The gap boundaries may include the start time of the tune-away period, the end time of the tune-away period, the duration of the tune-away period. The gap boundaries may be determined in absolute time and/or in relative time. In some examples, a gap manager of UE 405 may identify or otherwise determine the gap boundaries. The gap manager may correspond to a component/function of UE 405 that monitors, controls, or otherwise manages tune-away procedure of UE 405.

At 420, UE 405 may coordinate the SR prohibit time and the tune-away period. For example, the gap manager discussed above may coordinate with a grant manager regarding a SR transmission generated by UE 405. The grant manager may correspond to a component/function of UE 405 that monitors, controls, or otherwise manages aspects of SR transmissions of UE 405. Accordingly, in this example the gap manager may provide an indication of the gap boundaries to the grant manager. In response, the grant manager and/or gap manager may identify or otherwise determine the response window for the SR transmission (e.g., according to the techniques discussed above).

At 425, UE 405 may hold or otherwise pause the SR transmission based on the response window. For example, the grant manager may identify or otherwise determine that the response window would overlap with the tune-away period. This would otherwise result in the corresponding grant arriving at UE 405 during the tune-away period. Accordingly, UE 405 may pause the SR transmission. In some aspects, UE 405 may not coordinate with or otherwise inform base station 410 that is has held the SR transmission.

At 430, UE 405 may perform the tune-away procedure during the tune-away period. For example, UE 405 may tune away from base station 410 and, instead, tune to one or more neighboring base stations/cells for channel performance measurements, to monitor for paging, and the like.

At 435, UE 405 may transmit or otherwise provide (and base station 410 may receive or otherwise obtain) the SR requesting uplink resources. For example, the SR may indicate a resource request, may indicate the BSR, and the like. UE 405 may transmit the SR to base station 410 after completion of the tune-away procedure during the tune-away period.

At 440, base station 410 may transmit or otherwise provide (and UE 405 may receive or otherwise obtain) one or more grants of the uplink resources for the uplink transmission. The grant(s) may identify the time resources, frequency resources, spatial resources, code resources, etc., for UE 405 to use for performing the uplink transmission.

Accordingly at 445, UE 405 may transmit or otherwise provide (and base station 410 may receive or otherwise obtain) the uplink transmission. The uplink transmission may include physical uplink control channel (PUCCH) and/or PUSCH information and may be transmitted according to the granted uplink resources.

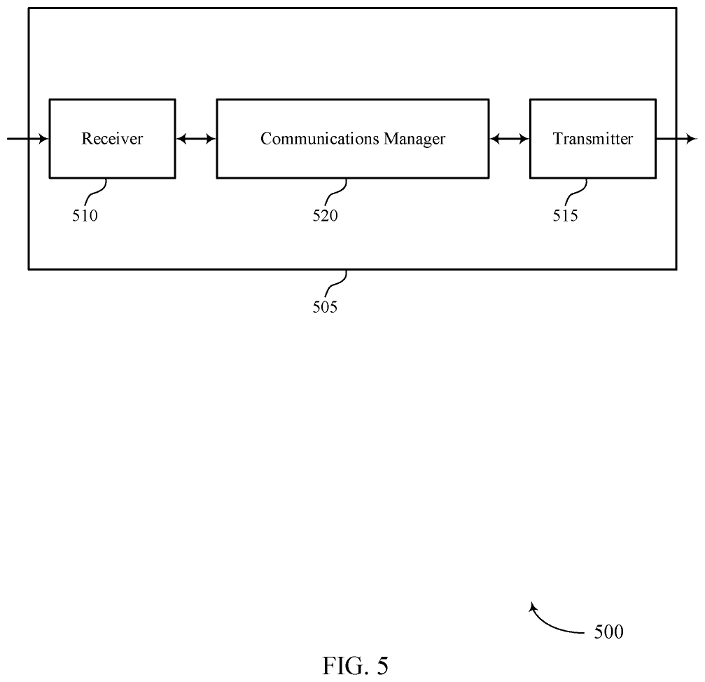

FIG. 5 shows a block diagram 500 of a device 505 that supports prevention of out-of-synchronization state due to UE tune-away in accordance with aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to prevention of out-of-synchronization state due to UE tune-away). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to prevention of out-of-synchronization state due to UE tune-away). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of prevention of out-of-synchronization state due to UE tune-away as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 520 may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communication at a UE in accordance with examples as disclosed herein. For example, the communications manager 520 may be configured as or otherwise support a means for generating a scheduling request for transmission to a base station. The communications manager 520 may be configured as or otherwise support a means for pausing a transmission of the scheduling request according to an overlap in time between a response window associated with the scheduling request and a scheduled tuneaway period of the UE. The communications manager 520 may be configured as or otherwise support a means for tuning away from the base station during the tuneaway period. The communications manager 520 may be configured as or otherwise support a means for transmitting the scheduling request after a completion of the tuneaway period according to the pausing.

By including or configuring the communications manager 520 in accordance with examples as described herein, the device 505 (e.g., a processor controlling or otherwise coupled to the receiver 510, the transmitter 515, the communications manager 520, or a combination thereof) may support techniques for avoiding out-of-synchronization scenario between a UE and base station by allowing the UE to pause SR transmissions prior to a tune-away of the UE.

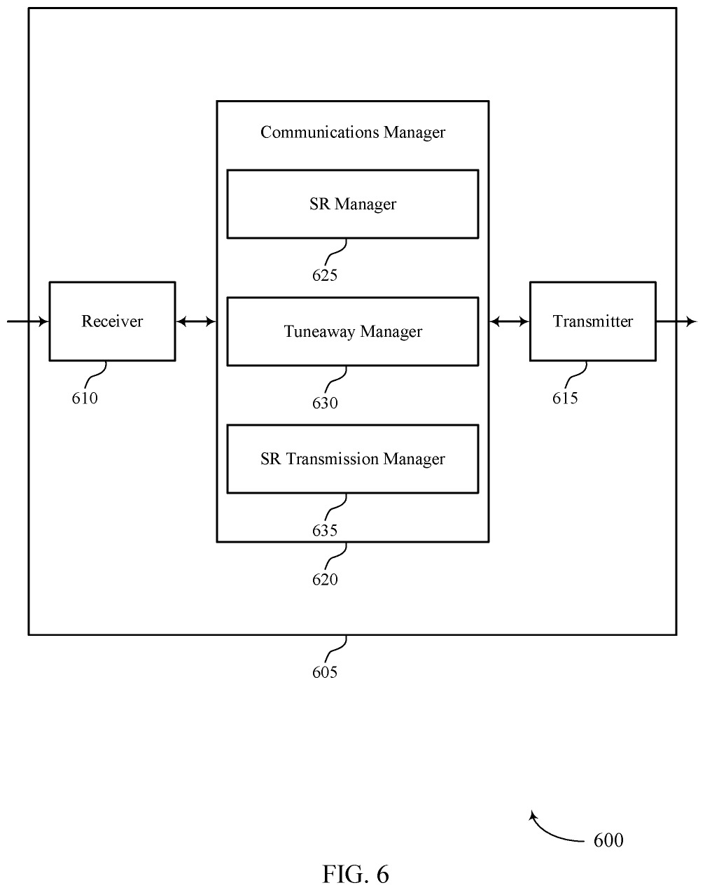

FIG. 6 shows a block diagram 600 of a device 605 that supports prevention of out-of-synchronization state due to UE tune-away in accordance with aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to prevention of out-of-synchronization state due to UE tune-away). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to prevention of out-of-synchronization state due to UE tune-away). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of prevention of out-of-synchronization state due to UE tune-away as described herein. For example, the communications manager 620 may include an SR manager 625, a tuneaway manager 630, an SR transmission manager 635, or any combination thereof. The communications manager 620 may be an example of aspects of a communications manager 520 as described herein. In some examples, the communications manager 620, or various components thereof, may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communication at a UE in accordance with examples as disclosed herein. The SR manager 625 may be configured as or otherwise support a means for generating a scheduling request for transmission to a base station. The SR manager 625 may be configured as or otherwise support a means for pausing a transmission of the scheduling request according to an overlap in time between a response window associated with the scheduling request and a scheduled tuneaway period of the UE. The tuneaway manager 630 may be configured as or otherwise support a means for tuning away from the base station during the tuneaway period. The SR transmission manager 635 may be configured as or otherwise support a means for transmitting the scheduling request after a completion of the tuneaway period according to the pausing.

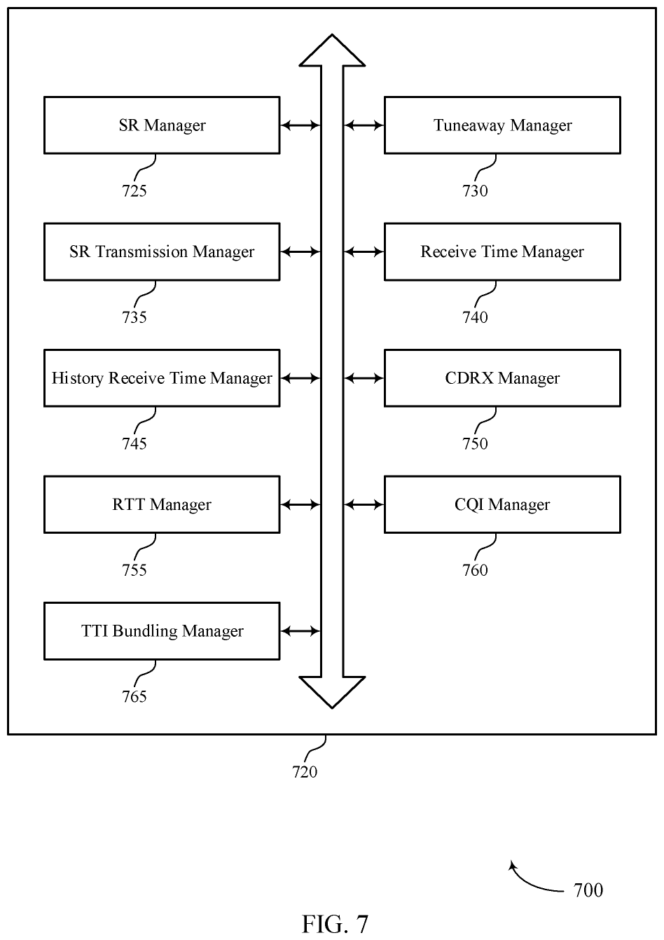

FIG. 7 shows a block diagram 700 of a communications manager 720 that supports prevention of out-of-synchronization state due to UE tune-away in accordance with aspects of the present disclosure. The communications manager 720 may be an example of aspects of a communications manager 520, a communications manager 620, or both, as described herein. The communications manager 720, or various components thereof, may be an example of means for performing various aspects of prevention of out-of-synchronization state due to UE tune-away as described herein. For example, the communications manager 720 may include an SR manager 725, a tuneaway manager 730, an SR transmission manager 735, a receive time manager 740, a history receive time manager 745, an CDRX manager 750, an RTT manager 755, a CQI manager 760, a TTI bundling manager 765, or any combination thereof. Each of these components may communicate, directly or indirectly, with one another (e.g., via one or more buses).

The communications manager 720 may support wireless communication at a UE in accordance with examples as disclosed herein. The SR manager 725 may be configured as or otherwise support a means for generating a scheduling request for transmission to a base station. In some examples, the SR manager 725 may be configured as or otherwise support a means for pausing a transmission of the scheduling request according to an overlap in time between a response window associated with the scheduling request and a scheduled tuneaway period of the UE. The tuneaway manager 730 may be configured as or otherwise support a means for tuning away from the base station during the tuneaway period. The SR transmission manager 735 may be configured as or otherwise support a means for transmitting the scheduling request after a completion of the tuneaway period according to the pausing.

In some examples, the receive time manager 740 may be configured as or otherwise support a means for determining a receive time for one or more grants of uplink resources for an uplink transmission associated with the scheduling request, where the response window is based on the receive time, where pausing the transmission of the scheduling request is based on the receive time occurring within the tuneaway period. In some examples, the determining is based on a machine-learning function or an estimation function performed at the UE.

In some examples, the history receive time manager 745 may be configured as or otherwise support a means for determining a historical receive time for one or more previous grants of uplink resources for respective uplink transmission associated with scheduling requests. In some examples, the history receive time manager 745 may be configured as or otherwise support a means for determining, based on the historical receive time, a receive time for one or more grants of uplink resources for an uplink transmission associated with the scheduling request, where the response window is based on the receive time, where pausing the transmission of the scheduling request is based on the receive time occurring within the tuneaway period.

In some examples, the receive time manager 740 may be configured as or otherwise support a means for determining a receive time for a one or more grants of uplink resources for an uplink transmission associated with the scheduling request, where the response window is based on the receive time. In some examples, the history receive time manager 745 may be configured as or otherwise support a means for transmitting an indication of the response window to the base station, where subsequent scheduling requests may be paused based on the indication. In some examples, the indication is transmitted via at least one of a UE assistance information request message, a MAC-CE, or both.

In some examples, the CDRX manager 750 may be configured as or otherwise support a means for determining a connected-mode discontinuous reception (CDRX) cycle associated with the UE, the CDRX cycle including the UE transitioning between a connected mode with the base station and an inactive or idle mode with the base station, where the response window is based on the CDRX cycle.

In some examples, the RTT manager 755 may be configured as or otherwise support a means for determining a RTT for transmissions between the UE and the base station, where the response window is based on the RTT.

In some examples, the CQI manager 760 may be configured as or otherwise support a means for determining that the scheduling request is associated with a CQI associated with a channel between the UE and the base station, where the response window is based on the CQI.

In some examples, the TTI bundling manager 765 may be configured as or otherwise support a means for determining at least one of a transmit time interval bundling configuration, a HARQ feedback configuration, or both, configured for the UE, where the response window is based on the determining.

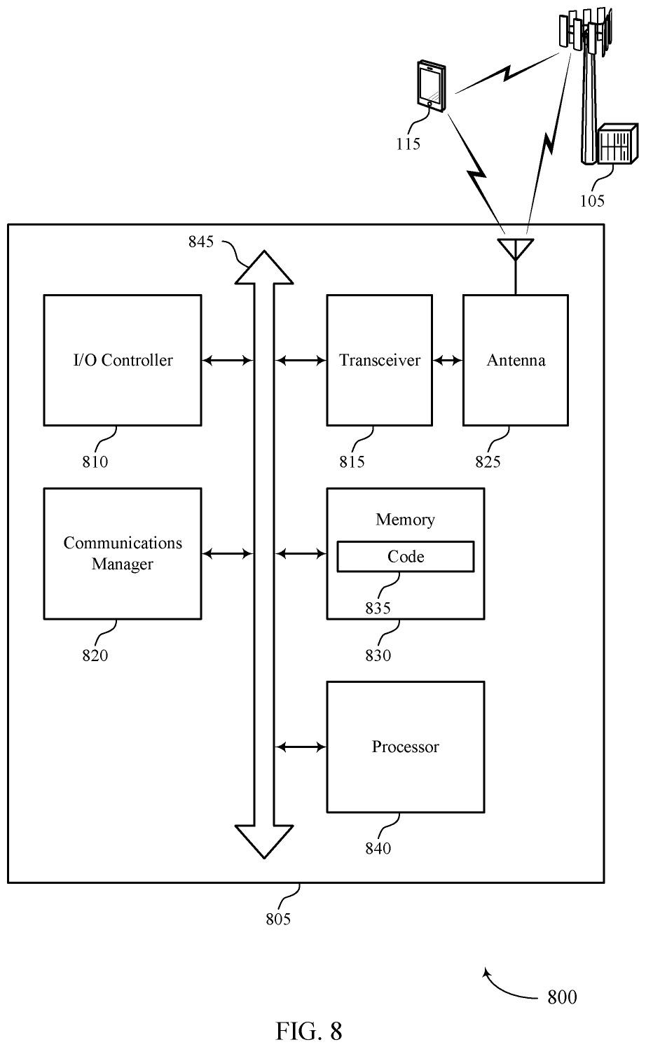

FIG. 8 shows a diagram of a system 800 including a device 805 that supports prevention of out-of-synchronization state due to UE tune-away in accordance with aspects of the present disclosure. The device 805 may be an example of or include the components of a device 505, a device 605, or a UE 115 as described herein. The device 805 may communicate wirelessly with one or more base stations 105, UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting prevention of out-of-synchronization state due to UE tune-away). For example, the device 805 or a component of the device 805 may include a processor 840 and memory 830 coupled to the processor 840, the processor 840 and memory 830 configured to perform various functions described herein.

The communications manager 820 may support wireless communication at a UE in accordance with examples as disclosed herein. For example, the communications manager 820 may be configured as or otherwise support a means for generating a scheduling request for transmission to a base station. The communications manager 820 may be configured as or otherwise support a means for pausing a transmission of the scheduling request according to an overlap in time between a response window associated with the scheduling request and a scheduled tuneaway period of the UE. The communications manager 820 may be configured as or otherwise support a means for tuning away from the base station during the tuneaway period. The communications manager 820 may be configured as or otherwise support a means for transmitting the scheduling request after a completion of the tuneaway period according to the pausing.

By including or configuring the communications manager 820 in accordance with examples as described herein, the device 805 may support techniques for avoiding out-of-synchronization scenario between a UE and base station by allowing the UE to pause SR transmissions prior to a tune-away of the UE.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of prevention of out-of-synchronization state due to UE tune-away as described herein, or the processor 840 and the memory 830 may be otherwise configured to perform or support such operations.

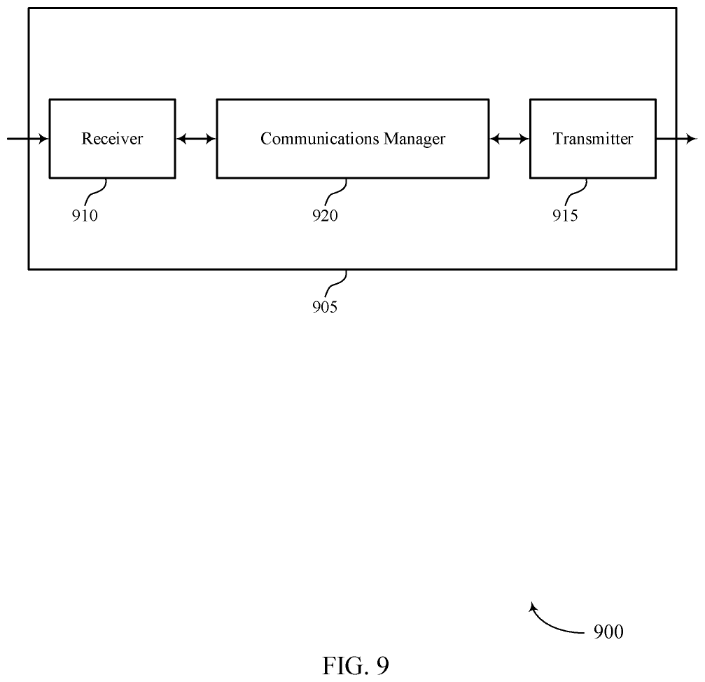

FIG. 9 shows a block diagram 900 of a device 905 that supports prevention of out-of-synchronization state due to UE tune-away in accordance with aspects of the present disclosure. The device 905 may be an example of aspects of a base station 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to prevention of out-of-synchronization state due to UE tune-away). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to prevention of out-of-synchronization state due to UE tune-away). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of prevention of out-of-synchronization state due to UE tune-away as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 920 may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communication at a base station in accordance with examples as disclosed herein. For example, the communications manager 920 may be configured as or otherwise support a means for receiving, from a UE, an indication of a response window associated with the UE, the response window based on an overlap in time between the response window associated with a first scheduling request of the UE and a scheduled tuneaway period of the UE where the UE tunes away from the base station. The communications manager 920 may be configured as or otherwise support a means for receiving a second scheduling request from the UE requesting a grant of uplink resources for an uplink transmission associated with the second scheduling request. The communications manager 920 may be configured as or otherwise support a means for scheduling transmission of one or more grants of the uplink resources for the uplink transmission basing at least in part on the response window of the UE.

By including or configuring the communications manager 920 in accordance with examples as described herein, the device 905 (e.g., a processor controlling or otherwise coupled to the receiver 910, the transmitter 915, the communications manager 920, or a combination thereof) may support techniques for avoiding out-of-synchronization scenario between a UE and base station by allowing the UE to pause SR transmissions prior to a tune-away of the UE.

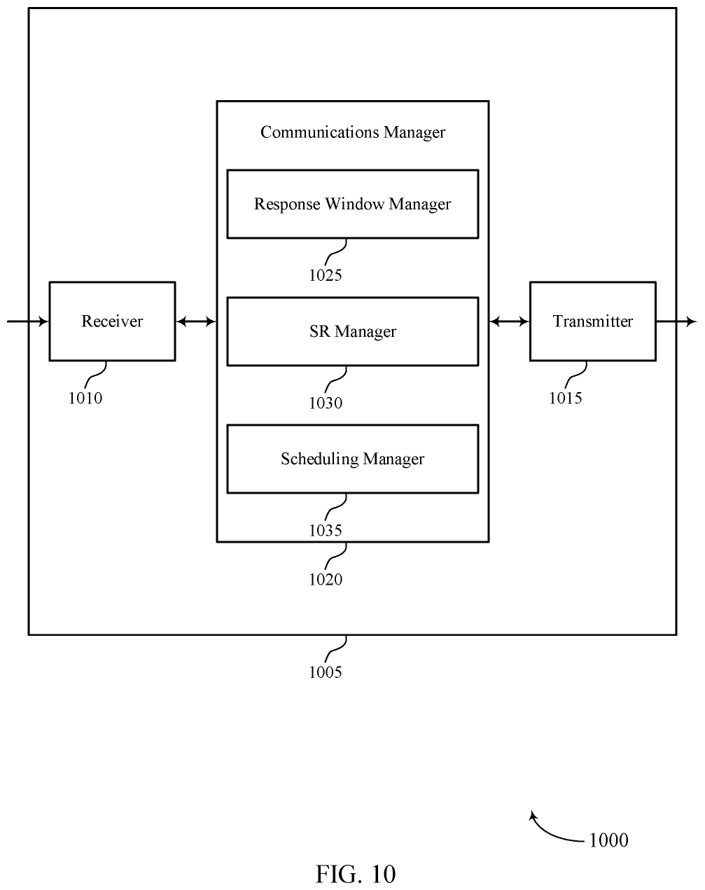

FIG. 10 shows a block diagram 1000 of a device 1005 that supports prevention of out-of-synchronization state due to UE tune-away in accordance with aspects of the present disclosure. The device 1005 may be an example of aspects of a device 905 or a base station 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to prevention of out-of-synchronization state due to UE tune-away). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to prevention of out-of-synchronization state due to UE tune-away). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of prevention of out-of-synchronization state due to UE tune-away as described herein. For example, the communications manager 1020 may include a response window manager 1025, an SR manager 1030, a scheduling manager 1035, or any combination thereof. The communications manager 1020 may be an example of aspects of a communications manager 920 as described herein. In some examples, the communications manager 1020, or various components thereof, may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communication at a base station in accordance with examples as disclosed herein. The response window manager 1025 may be configured as or otherwise support a means for receiving, from a UE, an indication of a response window associated with the UE, the response window based on an overlap in time between the response window associated with a first scheduling request of the UE and a scheduled tuneaway period of the UE where the UE tunes away from the base station. The SR manager 1030 may be configured as or otherwise support a means for receiving a second scheduling request from the UE requesting a grant of uplink resources for an uplink transmission associated with the second scheduling request. The scheduling manager 1035 may be configured as or otherwise support a means for scheduling transmission of one or more grants of the uplink resources for the uplink transmission based on the response window of the UE.

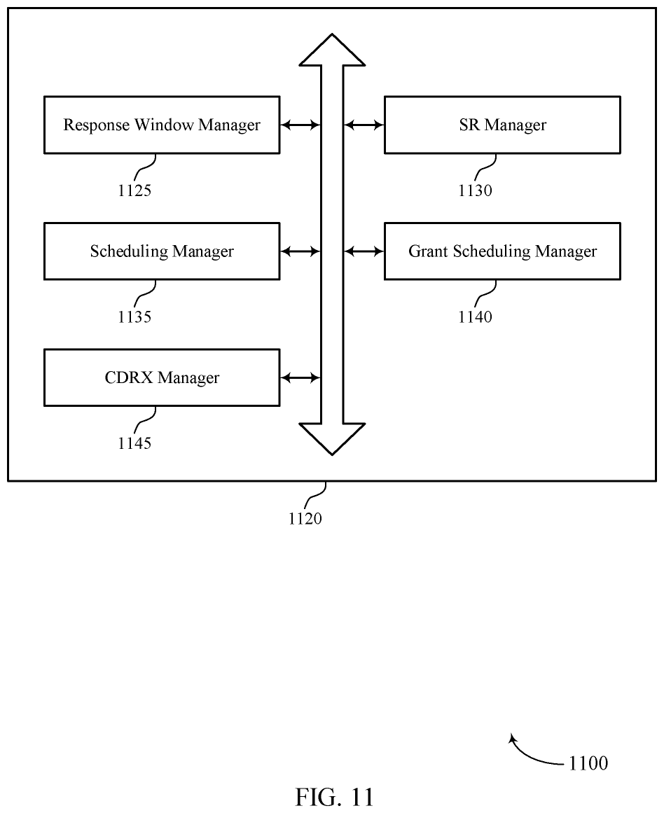

FIG. 11 shows a block diagram 1100 of a communications manager 1120 that supports prevention of out-of-synchronization state due to UE tune-away in accordance with aspects of the present disclosure. The communications manager 1120 may be an example of aspects of a communications manager 920, a communications manager 1020, or both, as described herein. The communications manager 1120, or various components thereof, may be an example of means for performing various aspects of prevention of out-of-synchronization state due to UE tune-away as described herein. For example, the communications manager 1120 may include a response window manager 1125, an SR manager 1130, a scheduling manager 1135, a grant scheduling manager 1140, an CDRX manager 1145, or any combination thereof. Each of these components may communicate, directly or indirectly, with one another (e.g., via one or more buses).

The communications manager 1120 may support wireless communication at a base station in accordance with examples as disclosed herein. The response window manager 1125 may be configured as or otherwise support a means for receiving, from a UE, an indication of a response window associated with the UE, the response window based on an overlap in time between the response window associated with a first scheduling request of the UE and a scheduled tuneaway period of the UE where the UE tunes away from the base station. The SR manager 1130 may be configured as or otherwise support a means for receiving a second scheduling request from the UE requesting a grant of uplink resources for an uplink transmission associated with the second scheduling request. The scheduling manager 1135 may be configured as or otherwise support a means for scheduling transmission of one or more grants of the uplink resources for the uplink transmission based on the response window of the UE.

In some examples, the grant scheduling manager 1140 may be configured as or otherwise support a means for determining that the UE is scheduled to tune away from the base station during the response window. In some examples, the grant scheduling manager 1140 may be configured as or otherwise support a means for scheduling a receive time for the one or more grants until after the tuneaway of the UE based on the response window and the tuneaway.

In some examples, the CDRX manager 1145 may be configured as or otherwise support a means for determining a CDRX cycle associated with the UE, the CDRX cycle including the UE transitioning between a connected mode with the base station and an inactive or idle mode with the base station, where the response window is based on the CDRX cycle. In some examples, the response window is based on a receive time for a received grant, a historical receive time for one or more previous grants, or both. In some examples, the indication is received via at least one of a UE assistance information request message, a MAC-CE, or both.

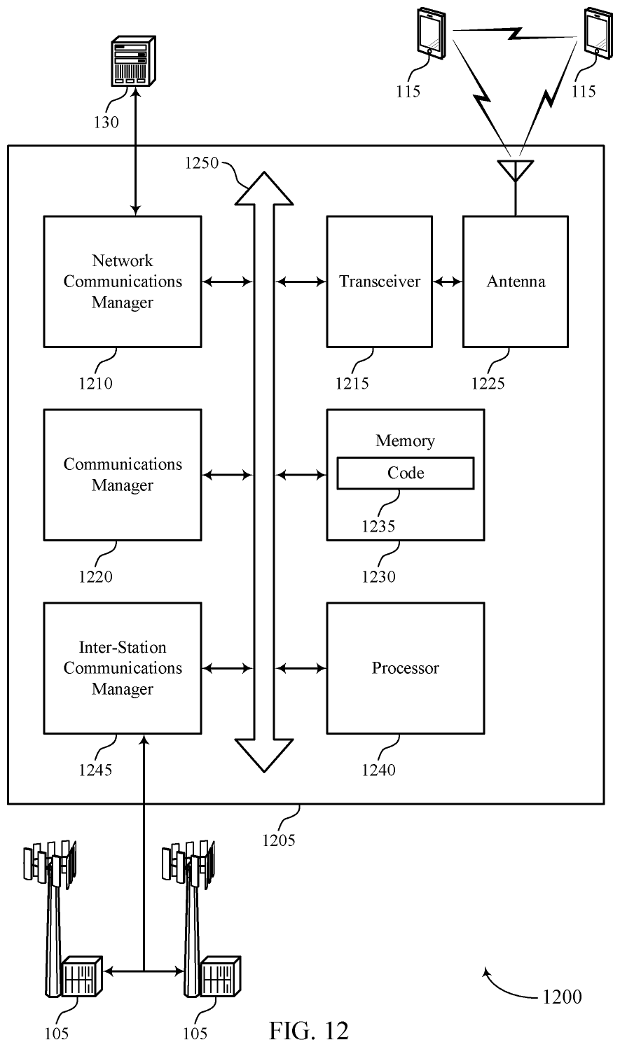

FIG. 12 shows a diagram of a system 1200 including a device 1205 that supports prevention of out-of-synchronization state due to UE tune-away in accordance with aspects of the present disclosure. The device 1205 may be an example of or include the components of a device 905, a device 1005, or a base station 105 as described herein. The device 1205 may communicate wirelessly with one or more base stations 105, UEs 115, or any combination thereof. The device 1205 may include components for bi-directional voice and data communications including components for transmitting and receiving communications, such as a communications manager 1220, a network communications manager 1210, a transceiver 1215, an antenna 1225, a memory 1230, code 1235, a processor 1240, and an inter-station communications manager 1245. These components may be in electronic communication or otherwise coupled (e.g., operatively, communicatively, functionally, electronically, electrically) via one or more buses (e.g., a bus 1250).

The network communications manager 1210 may manage communications with a core network 130 (e.g., via one or more wired backhaul links). For example, the network communications manager 1210 may manage the transfer of data communications for client devices, such as one or more UEs 115.

In some cases, the device 1205 may include a single antenna 1225. However, in some other cases the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include RAM and ROM. The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a BIOS which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting prevention of out-of-synchronization state due to UE tune-away). For example, the device 1205 or a component of the device 1205 may include a processor 1240 and memory 1230 coupled to the processor 1240, the processor 1240 and memory 1230 configured to perform various functions described herein.

The inter-station communications manager 1245 may manage communications with other base stations 105, and may include a controller or scheduler for controlling communications with UEs 115 in cooperation with other base stations 105. For example, the inter-station communications manager 1245 may coordinate scheduling for transmissions to UEs 115 for various interference mitigation techniques such as beamforming or joint transmission. In some examples, the inter-station communications manager 1245 may provide an X2 interface within an LTE/LTE-A wireless communications network technology to provide communication between base stations 105.

The communications manager 1220 may support wireless communication at a base station in accordance with examples as disclosed herein. For example, the communications manager 1220 may be configured as or otherwise support a means for receiving, from a UE, an indication of a response window associated with the UE, the response window based on an overlap in time between the response window associated with a first scheduling request of the UE and a scheduled tuneaway period of the UE where the UE tunes away from the base station. The communications manager 1220 may be configured as or otherwise support a means for receiving a second scheduling request from the UE requesting a grant of uplink resources for an uplink transmission associated with the second scheduling request. The communications manager 1220 may be configured as or otherwise support a means for scheduling transmission of one or more grants of the uplink resources for the uplink transmission basing at least in part on the response window of the UE.

By including or configuring the communications manager 1220 in accordance with examples as described herein, the device 1205 may support techniques for avoiding out-of-synchronization scenario between a UE and base station by allowing the UE to pause SR transmissions prior to a tune-away of the UE.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of prevention of out-of-synchronization state due to UE tune-away as described herein, or the processor 1240 and the memory 1230 may be otherwise configured to perform or support such operations.

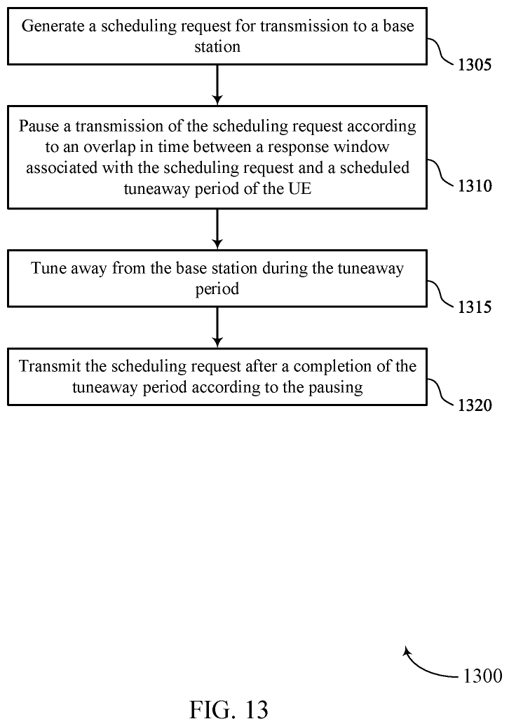

FIG. 13 shows a flowchart illustrating a method 1300 that supports prevention of out-of-synchronization state due to UE tune-away in accordance with aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1305, the method may include generating a scheduling request for transmission to a base station. The operations of 1305 may be performed in accordance with examples as disclosed herein. In some examples, aspects of the operations of 1305 may be performed by an SR manager 725 as described with reference to FIG. 7.

At 1310, the method may include pausing a transmission of the scheduling request according to an overlap in time between a response window associated with the scheduling request and a scheduled tuneaway period of the UE. The operations of 1310 may be performed in accordance with examples as disclosed herein. In some examples, aspects of the operations of 1310 may be performed by an SR manager 725 as described with reference to FIG. 7.

At 1315, the method may include tuning away from the base station during the tuneaway period. The operations of 1315 may be performed in accordance with examples as disclosed herein. In some examples, aspects of the operations of 1315 may be performed by a tuneaway manager 730 as described with reference to FIG. 7.

At 1320, the method may include transmitting the scheduling request after a completion of the tuneaway period according to the pausing. The operations of 1320 may be performed in accordance with examples as disclosed herein. In some examples, aspects of the operations of 1320 may be performed by an SR transmission manager 735 as described with reference to FIG. 7.

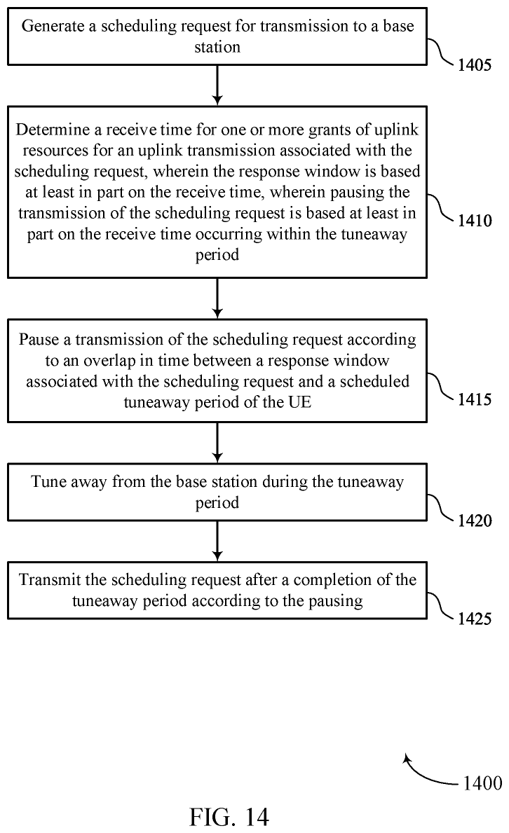

FIG. 14 shows a flowchart illustrating a method 1400 that supports prevention of out-of-synchronization state due to UE tune-away in accordance with aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1405, the method may include generating a scheduling request for transmission to a base station. The operations of 1405 may be performed in accordance with examples as disclosed herein. In some examples, aspects of the operations of 1405 may be performed by an SR manager 725 as described with reference to FIG. 7.

At 1410, the method may include determining a receive time for one or more grants of uplink resources for an uplink transmission associated with the scheduling request, where the response window is based on the receive time, where pausing the transmission of the scheduling request is based on the receive time occurring within the tuneaway period. The operations of 1410 may be performed in accordance with examples as disclosed herein. In some examples, aspects of the operations of 1410 may be performed by a receive time manager 740 as described with reference to FIG. 7.

At 1415, the method may include pausing a transmission of the scheduling request according to an overlap in time between a response window associated with the scheduling request and a scheduled tuneaway period of the UE. The operations of 1415 may be performed in accordance with examples as disclosed herein. In some examples, aspects of the operations of 1415 may be performed by an SR manager 725 as described with reference to FIG. 7.

At 1420, the method may include tuning away from the base station during the tuneaway period. The operations of 1420 may be performed in accordance with examples as disclosed herein. In some examples, aspects of the operations of 1420 may be performed by a tuneaway manager 730 as described with reference to FIG. 7.

At 1425, the method may include transmitting the scheduling request after a completion of the tuneaway period according to the pausing. The operations of 1425 may be performed in accordance with examples as disclosed herein. In some examples, aspects of the operations of 1425 may be performed by an SR transmission manager 735 as described with reference to FIG. 7.

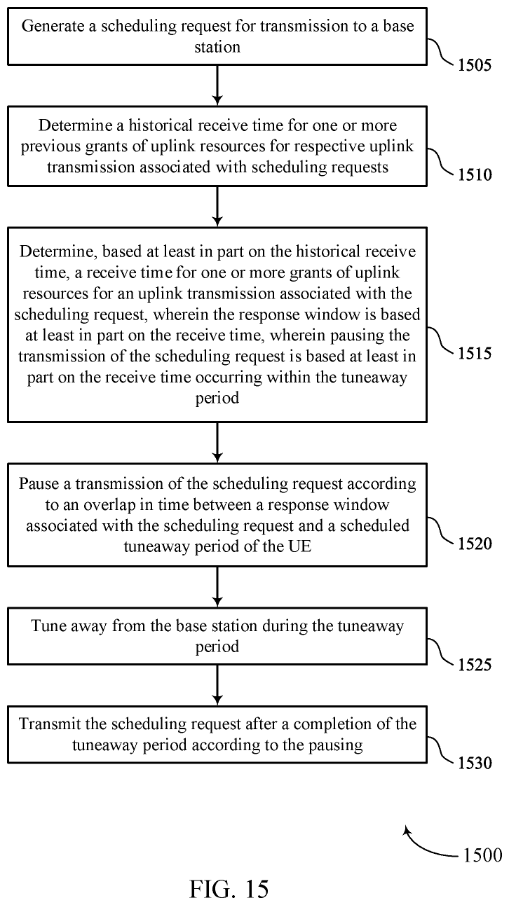

FIG. 15 shows a flowchart illustrating a method 1500 that supports prevention of out-of-synchronization state due to UE tune-away in accordance with aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1505, the method may include generating a scheduling request for transmission to a base station. The operations of 1505 may be performed in accordance with examples as disclosed herein. In some examples, aspects of the operations of 1505 may be performed by an SR manager 725 as described with reference to FIG. 7.

At 1510, the method may include determining a historical receive time for one or more previous grants of uplink resources for respective uplink transmission associated with scheduling requests. The operations of 1510 may be performed in accordance with examples as disclosed herein. In some examples, aspects of the operations of 1510 may be performed by a history receive time manager 745 as described with reference to FIG. 7.

At 1515, the method may include determining, based on the historical receive time, a receive time for one or more grants of uplink resources for an uplink transmission associated with the scheduling request, where the response window is based on the receive time, where pausing the transmission of the scheduling request is based on the receive time occurring within the tuneaway period. The operations of 1515 may be performed in accordance with examples as disclosed herein. In some examples, aspects of the operations of 1515 may be performed by a history receive time manager 745 as described with reference to FIG. 7.

At 1520, the method may include pausing a transmission of the scheduling request according to an overlap in time between a response window associated with the scheduling request and a scheduled tuneaway period of the UE. The operations of 1520 may be performed in accordance with examples as disclosed herein. In some examples, aspects of the operations of 1520 may be performed by an SR manager 725 as described with reference to FIG. 7.

At 1525, the method may include tuning away from the base station during the tuneaway period. The operations of 1525 may be performed in accordance with examples as disclosed herein. In some examples, aspects of the operations of 1525 may be performed by a tuneaway manager 730 as described with reference to FIG. 7.

At 1530, the method may include transmitting the scheduling request after a completion of the tuneaway period according to the pausing. The operations of 1530 may be performed in accordance with examples as disclosed herein. In some examples, aspects of the operations of 1530 may be performed by an SR transmission manager 735 as described with reference to FIG. 7.

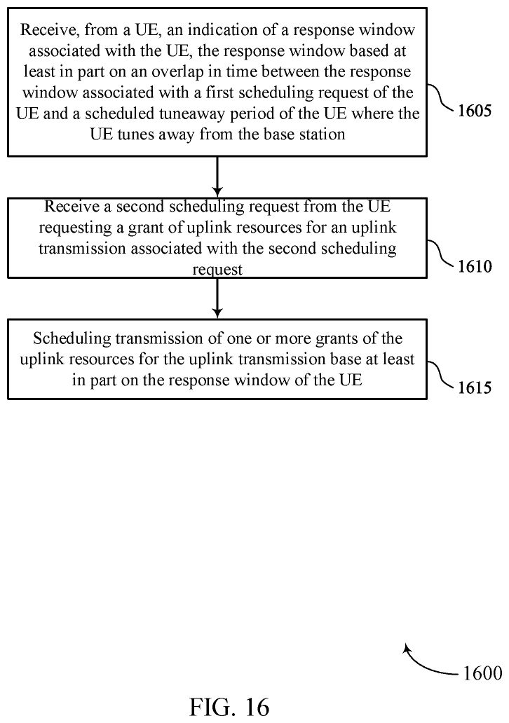

FIG. 16 shows a flowchart illustrating a method 1600 that supports prevention of out-of-synchronization state due to UE tune-away in accordance with aspects of the present disclosure. The operations of the method 1600 may be implemented by a base station or its components as described herein. For example, the operations of the method 1600 may be performed by a base station 105 as described with reference to FIGS. 1 through 4 and 9 through 12. In some examples, a base station may execute a set of instructions to control the functional elements of the base station to perform the described functions. Additionally or alternatively, the base station may perform aspects of the described functions using special-purpose hardware.

At 1605, the method may include receiving, from a UE, an indication of a response window associated with the UE, the response window based on an overlap in time between the response window associated with a first scheduling request of the UE and a scheduled tuneaway period of the UE where the UE tunes away from the base station. The operations of 1605 may be performed in accordance with examples as disclosed herein. In some examples, aspects of the operations of 1605 may be performed by a response window manager 1125 as described with reference to FIG. 11.

At 1610, the method may include receiving a second scheduling request from the UE requesting a grant of uplink resources for an uplink transmission associated with the second scheduling request. The operations of 1610 may be performed in accordance with examples as disclosed herein. In some examples, aspects of the operations of 1610 may be performed by an SR manager 1130 as described with reference to FIG. 11.

At 1615, the method may include scheduling transmission of one or more grants of the uplink resources for the uplink transmission based on the response window of the UE. The operations of 1615 may be performed in accordance with examples as disclosed herein. In some examples, aspects of the operations of 1615 may be performed by a scheduling manager 1135 as described with reference to FIG. 11.

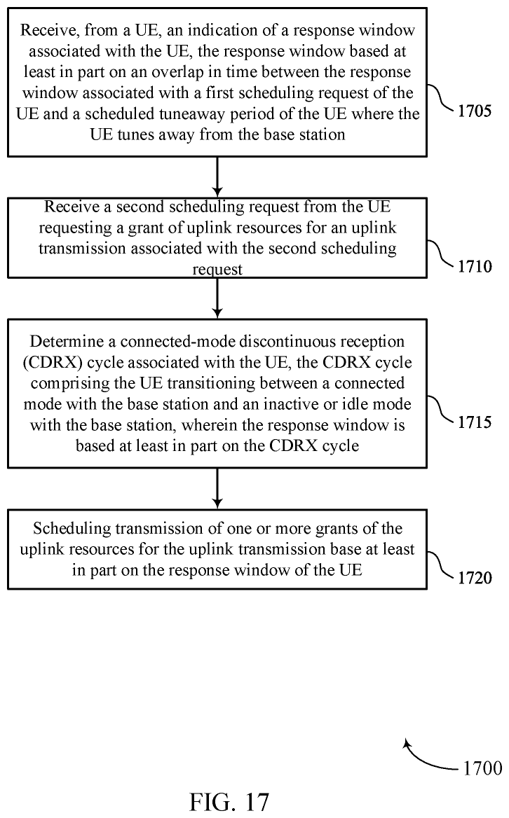

FIG. 17 shows a flowchart illustrating a method 1700 that supports prevention of out-of-synchronization state due to UE tune-away in accordance with aspects of the present disclosure. The operations of the method 1700 may be implemented by a base station or its components as described herein. For example, the operations of the method 1700 may be performed by a base station 105 as described with reference to FIGS. 1 through 4 and 9 through 12. In some examples, a base station may execute a set of instructions to control the functional elements of the base station to perform the described functions. Additionally or alternatively, the base station may perform aspects of the described functions using special-purpose hardware.

At 1705, the method may include receiving, from a UE, an indication of a response window associated with the UE, the response window based on an overlap in time between the response window associated with a first scheduling request of the UE and a scheduled tuneaway period of the UE where the UE tunes away from the base station. The operations of 1705 may be performed in accordance with examples as disclosed herein. In some examples, aspects of the operations of 1705 may be performed by a response window manager 1125 as described with reference to FIG. 11.

At 1710, the method may include receiving a second scheduling request from the UE requesting a grant of uplink resources for an uplink transmission associated with the second scheduling request. The operations of 1710 may be performed in accordance with examples as disclosed herein. In some examples, aspects of the operations of 1710 may be performed by an SR manager 1130 as described with reference to FIG. 11.

At 1715, the method may include determining a connected-mode discontinuous reception (CDRX) cycle associated with the UE, the CDRX cycle including the UE transitioning between a connected mode with the base station and an inactive or idle mode with the base station, where the response window is based on the CDRX cycle. The operations of 1715 may be performed in accordance with examples as disclosed herein. In some examples, aspects of the operations of 1715 may be performed by an CDRX manager 1145 as described with reference to FIG. 11.

At 1720, the method may include scheduling transmission of one or more grants of the uplink resources for the uplink transmission based on the response window of the UE. The operations of 1720 may be performed in accordance with examples as disclosed herein. In some examples, aspects of the operations of 1720 may be performed by a scheduling manager 1135 as described with reference to FIG. 11.

The following provides an overview of aspects of the present disclosure:

Aspect 1: A method for wireless communications at a UE, comprising: generating a SR for transmission to a base station; pausing a transmission of the SR according to an overlap in time between a response window associated with the SR and a scheduled tuneaway period of the UE; tuning away from the base station during the tuneaway period; and transmitting the SR after a completion of the tuneaway period according to the pausing.

Aspect 2: The method of aspect 1, further comprising: determining a receive time for one or more grants of uplink resources for an uplink transmission associated with the SR, wherein the response window is based at least in part on the receive time, wherein pausing the transmission of the SR is based at least in part on the receive time occurring within the tuneaway period.

Aspect 3: The method of aspect 2, wherein the determining is based at least in part on a machine-learning function or an estimation function performed at the UE.

Aspect 4: The method of any of aspects 1 through 3, further comprising: determining a historical receive time for one or more previous grants of uplink resources for respective uplink transmission associated with SRs; and determining, based at least in part on the historical receive time, a receive time for one or more grants of uplink resources for an uplink transmission associated with the SR, wherein the response window is based at least in part on the receive time, wherein pausing the transmission of the SR is based at least in part on the receive time occurring within the tuneaway period.

Aspect 5: The method of any of aspects 1 through 4, further comprising: determining a receive time for a one or more grants of uplink resources for an uplink transmission associated with the SR, wherein the response window is based at least in part on the receive time; and transmitting an indication of the response window to the base station, wherein subsequent SRs may be paused based at least in part on the indication.

Aspect 6: The method of aspect 5, wherein the indication is transmitted via at least one of a UE assistance information request message, a MAC-CE, or both.

Aspect 7: The method of any of aspects 1 through 6, further comprising: determining a CDRX cycle associated with the UE, the CDRX cycle comprising the UE transitioning between a connected mode with the base station and an inactive or idle mode with the base station, wherein the response window is based at least in part on the CDRX cycle.

Aspect 8: The method of any of aspects 1 through 7, further comprising: determining a RTT for transmissions between the UE and the base station, wherein the response window is based at least in part on the RTT.

Aspect 9: The method of any of aspects 1 through 8, further comprising: determining that the SR is associated with a CQI associated with a channel between the UE and the base station, wherein the response window is based at least in part on the CQI.

Aspect 10: The method of any of aspects 1 through 9, further comprising: determining at least one of a transmit time interval bundling configuration, a HARQ feedback configuration, or both, configured for the UE, wherein the response window is based at least in part on the determining.

Aspect 11: A method for wireless communications at a base station, comprising: receiving, from a UE, an indication of a response window associated with the UE, the response window based at least in part on an overlap in time between the response window associated with a first SR of the UE and a scheduled tuneaway period of the UE where the UE tunes away from the base station; receiving a second SR from the UE requesting a grant of uplink resources for an uplink transmission associated with the second SR; and scheduling transmission of one or more grants of the uplink resources for the uplink transmission based at least in part on the response window of the UE.

Aspect 12: The method of aspect 11, further comprising: determining that the UE is scheduled to tune away from the base station during the response window; and scheduling a receive time for the one or more grants until after the tuneaway of the UE based at least in part on the response window and the tuneaway.

Aspect 13: The method of any of aspects 11 through 12, further comprising: determining a CDRX cycle associated with the UE, the CDRX cycle comprising the UE transitioning between a connected mode with the base station and an inactive or idle mode with the base station, wherein the response window is based at least in part on the CDRX cycle.

Aspect 14: The method of any of aspects 11 through 13, wherein the response window is based at least in part on a receive time for a received grant, a historical receive time for one or more previous grants, or both.

Aspect 15: The method of any of aspects 11 through 14, wherein the indication is received via at least one of a UE assistance information request message, a MAC-CE, or both.

Aspect 16: An apparatus for wireless communications at a UE, comprising a processor; memory coupled with the processor; and instructions stored in the memory and executable by the processor to cause the apparatus to perform a method of any of aspects 1 through 10.

Aspect 17: An apparatus for wireless communications at a UE, comprising at least one means for performing a method of any of aspects 1 through 10.

Aspect 18: A non-transitory computer-readable medium storing code for wireless communications at a UE, the code comprising instructions executable by a processor to perform a method of any of aspects 1 through 10.

Aspect 19: An apparatus for wireless communications at a base station, comprising a processor; memory coupled with the processor; and instructions stored in the memory and executable by the processor to cause the apparatus to perform a method of any of aspects 11 through 15.

Aspect 20: An apparatus for wireless communications at a base station, comprising at least one means for performing a method of any of aspects 11 through 15.

Aspect 21: A non-transitory computer-readable medium storing code for wireless communications at a base station, the code comprising instructions executable by a processor to perform a method of any of aspects 11 through 15.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
generating a scheduling request for transmission to a base station;
pausing a transmission of the scheduling request according to an overlap in time between a response window associated with the scheduling request and a scheduled tuneaway period of the UE;
tuning away from the base station during the tuneaway period; and
transmitting the scheduling request after a completion of the tuneaway period according to the pausing.

2. The method of claim 1, further comprising:
determining a receive time for one or more grants of uplink resources for an uplink transmission associated with the scheduling request, wherein the response window is based at least in part on the receive time, wherein pausing the transmission of the scheduling request is based at least in part on the receive time occurring within the tuneaway period.

3. The method of claim 2, wherein the determining is based at least in part on a machine-learning function or an estimation function performed at the UE.

4. The method of claim 1, further comprising:
determining a historical receive time for one or more previous grants of uplink resources for respective uplink transmission associated with scheduling requests; and
determining, based at least in part on the historical receive time, a receive time for one or more grants of uplink resources for an uplink transmission associated with the scheduling request, wherein the response window is based at least in part on the receive time, wherein pausing the transmission of the scheduling request is based at least in part on the receive time occurring within the tuneaway period.

5. The method of claim 1, further comprising:
determining a receive time for a one or more grants of uplink resources for an uplink transmission associated with the scheduling request, wherein the response window is based at least in part on the receive time; and
transmitting an indication of the response window to the base station, wherein subsequent scheduling requests may be paused based at least in part on the indication.

6. The method of claim 5, wherein the indication is transmitted via at least one of a UE assistance information request message, a medium access control-control element (MAC-CE), or both.

7. The method of claim 1, further comprising:
determining a connected-mode discontinuous reception (CDRX) cycle associated with the UE, the CDRX cycle comprising the UE transitioning between a connected mode with the base station and an inactive or idle mode with the base station, wherein the response window is based at least in part on the CDRX cycle.

8. The method of claim 1, further comprising:
determining a roundtrip time (RTT) for transmissions between the UE and the base station, wherein the response window is based at least in part on the RTT.

9. The method of claim 1, further comprising:
determining that the scheduling request is associated with a channel quality indicator (CQI) associated with a channel between the UE and the base station, wherein the response window is based at least in part on the CQI.

10. The method of claim 1, further comprising:
determining at least one of a transmit time interval bundling configuration, a hybrid automatic repeat/request (HARQ) feedback configuration, or both, configured for the UE, wherein the response window is based at least in part on the determining.

11. A method for wireless communications at a base station, comprising:
receiving, from a user equipment (UE), an indication of a response window associated with the UE, the response window based at least in part on an overlap in time between the response window associated with a first scheduling request of the UE and a scheduled tuneaway period of the UE where the UE tunes away from the base station;
receiving a second scheduling request from the UE requesting a grant of uplink resources for an uplink transmission associated with the second scheduling request; and
scheduling transmission of one or more grants of the uplink resources for the uplink transmission based at least in part on the response window of the UE.

12. The method of claim 11, further comprising:
determining that the UE is scheduled to tune away from the base station during the response window; and
scheduling a receive time for the one or more grants until after the tuneaway of the UE based at least in part on the response window and the tuneaway.

13. The method of claim 11, further comprising:
determining a connected-mode discontinuous reception (CDRX) cycle associated with the UE, the CDRX cycle comprising the UE transitioning between a connected mode with the base station and an inactive or idle mode with the base station, wherein the response window is based at least in part on the CDRX cycle.

14. The method of claim 11, wherein the response window is based at least in part on a receive time for a received grant, a historical receive time for one or more previous grants, or both.

15. The method of claim 11, wherein the indication is received via at least one of a UE assistance information request message, a medium access control-control element (MAC-CE), or both.

16. An apparatus for wireless communications at a user equipment (UE), comprising:
a processor;
memory in electronic communication with the processor; and
instructions stored in the memory, wherein the instructions are executable by the processor to:
generate a scheduling request for transmission to a base station;
pause a transmission of the scheduling request according to an overlap in time between a response window associated with the scheduling request and a scheduled tuneaway period of the UE;
tune away from the base station during the tuneaway period; and
transmit the scheduling request after a completion of the tuneaway period according to the pausing.

17. The apparatus of claim 16, wherein the instructions are further executable by the processor to:
determine a receive time for one or more grants of uplink resources for an uplink transmission associated with the scheduling request, wherein the response window is based at least in part on the receive time, wherein pausing the transmission of the scheduling request is based at least in part on the receive time occurring within the tuneaway period.

18. The apparatus of claim 17, wherein the determining is based at least in part on a machine-learning function or an estimation function performed at the UE.

19. The apparatus of claim 16, wherein the instructions are further executable by the processor to:
determine a historical receive time for one or more previous grants of uplink resources for respective uplink transmission associated with scheduling requests; and
determine, based at least in part on the historical receive time, a receive time for one or more grants of uplink resources for an uplink transmission associated with the scheduling request, wherein the response window is based at least in part on the receive time, wherein pausing the transmission of the scheduling request is based at least in part on the receive time occurring within the tuneaway period.

20. The apparatus of claim 16, wherein the instructions are further executable by the processor to:
determine a receive time for a one or more grants of uplink resources for an uplink transmission associated with the scheduling request, wherein the response window is based at least in part on the receive time; and
transmit an indication of the response window to the base station, wherein subsequent scheduling requests may be paused based at least in part on the indication.

21. The apparatus of claim 20, wherein the indication is transmitted via at least one of a UE assistance information request message, a medium access control-control element (MAC-CE), or both.

22. The apparatus of claim 16, wherein the instructions are further executable by the processor to:
determine a connected-mode discontinuous reception (CDRX) cycle associated with the UE, the CDRX cycle comprising the UE transitioning between a connected mode with the base station and an inactive or idle mode with the base station, wherein the response window is based at least in part on the CDRX cycle.

23. The apparatus of claim 16, wherein the instructions are further executable by the processor to:
determine a roundtrip time (RTT) for transmissions between the UE and the base station, wherein the response window is based at least in part on the RTT.

24. The apparatus of claim 16, wherein the instructions are further executable by the processor to:
determine that the scheduling request is associated with a channel quality indicator (CQI) associated with a channel between the UE and the base station, wherein the response window is based at least in part on the CQI.

25. The apparatus of claim 16, wherein the instructions are further executable by the processor to:
determine at least one of a transmit time interval bundling configuration, a hybrid automatic repeat/request (HARQ) feedback configuration, or both, configured for the UE, wherein the response window is based at least in part on the determining.

26. An apparatus for wireless communications at a base station, comprising:
a processor;
memory in electronic communication with the processor; and
instructions stored in the memory, wherein the instructions are executable by the processor to:
receive, from a user equipment (UE), an indication of a response window associated with the UE, the response window based at least in part on an overlap in time between the response window associated with a first scheduling request of the UE and a scheduled tuneaway period of the UE where the UE tunes away from the base station;
receive a second scheduling request from the UE requesting a grant of uplink resources for an uplink transmission associated with the second scheduling request; and
scheduling transmission of one or more grants of the uplink resources for the uplink transmission base at least in part on the response window of the UE.

27. The apparatus of claim 26, wherein the instructions are further executable by the processor to:
determine that the UE is scheduled to tune away from the base station during the response window; and
schedule a receive time for the one or more grants until after the tuneaway of the UE based at least in part on the response window and the tuneaway.

28. The apparatus of claim 26, wherein the instructions are further executable by the processor to:
determine a connected-mode discontinuous reception (CDRX) cycle associated with the UE, the CDRX cycle comprising the UE transitioning between a connected mode with the base station and an inactive or idle mode with the base station, wherein the response window is based at least in part on the CDRX cycle.

29. The apparatus of claim 26, wherein the response window is based at least in part on a receive time for a received grant, a historical receive time for one or more previous grants, or both.

30. The apparatus of claim 26, wherein the indication is received via at least one of a UE assistance information request message, a medium access control-control element (MAC-CE), or both.
